(19) United States
(12) Patent Application Publication
(10) Pub. No.: US 2017/0051853 A1
(43) Pub. Date: Feb. 23, 2017

(54) Pipe Joint Structure

(71) Applicant: Wen-Kuei Wu, Taichung City (TW)

(72) Inventor: Wen-Kuei Wu, Taichung City (TW)

(21) Appl. No.: 14/829,019

(22) Filed: Aug. 18, 2015

(51) Int. Cl. F16L 15/08; F16L 21/08

(52) U.S. Cl. CPC F16L 15/08; F16L 21/08

(57) ABSTRACT

A pipe joint structure contains: a body, a connection ring, and a screwing nut. The body includes a hollow channel defined therein, a connecting tube surrounding around the hollow channel and having at least one open end, and a coupling section arranged adjacent to an end portion of an outer wall of the connecting tube. The connection ring includes an inner joining diameter for connecting with the coupling section. The screwing nut includes an internal orifice, an outer diameter of which is greater than the body and the connection ring. The internal orifice has first inner threads formed around inner wall thereof and has a limiting rib arranged on one end of the internal orifice facing to the body, wherein an outer diameter of the internal orifice is greater than an outer diameter of the body and is smaller than an outer diameter of the connection ring.

### BACKGROUND OF THE INVENTION

Field of the Invention

The present invention relates to a pipe joint structure which is adapted to connect at least one tube to convey fluid, such as liquid or gas.

Description of the Prior Art

Fluid, such as liquid or gas is accommodated in a container connected with at least one tube by means of various pipe joints applicable for petrochemical, chemical, or food industry at high pressure and in high acid alkali condition.

With reference to FIGS. 1 and 2, a conventional pipe joint contains: a body 10 including a hollowly open first connector 11 and a stepped connecting portion 12 disposed on an end portion of the first connector 11;

a screwing nut 20 including an internal orifice 21, a diameter of which is greater than an outer diameter of the first connector 11, wherein the internal orifice 21 has inner threads 22 defined on an inner wall thereof and has a limiting rib 23 arranged on one end of the internal orifice 21 facing to the body 10, and a diameter of the limiting rib 23 is greater than an outer diameter of the limiting rib 23;

a second connector 30 being hollow and including an outer diameter smaller than the diameter of the internal orifice 21 of the screwing nut 20, the second connector 30 including a coupling portion 31 formed on one end thereof facing to the body 10 to match with the stepped connecting portion 12 of the body 10, the second connector 30 also including a confining fringe 32 arranged on an outer wall thereof, wherein an outer diameter of the confining fringe 32 is smaller than the internal orifice 21 of the screwing nut 20 and is greater than the limiting rib 23.

In assembly, after the coupling portion 31 of the second connector 30 is inserted into the internal orifice 21 of the screwing nut 20, the coupling portion 31 of the second connector 30 connects with the stepped connecting portion 12 of the body 10, as shown in FIG. 3, between the second connector 30 and the body 10 are defined an internal joining line A1 and an external joining line A2, and the internal joining line A1 of the second connector 30 is welded with and the external joining line A2 of the body 10 to form an inner welding line B1 and an outer welding line B2, as illustrated in FIGS. 4 and 5, and a hollow space between the body 10 and the second connector 30 is defined a channel C at which the inner welding line B1 is located.

Thereby, a part of the second connector 30 is joined with a connecting tube 40 with outer threads 41 to screw with the inner threads 22 of the screwing nut 20, such that the second connector 30 is joined with the connecting tube 40 tightly. Preferably, between the second connector 30 and the connecting tube 40 is defined a closing ring 300 to stop the liquid. Referring to FIG. 6, the channel C is defined between the body 10 and the second connector 30 to form the inner welding line B1. Accordingly, when the fluid flows through the channel C in a stepped difference, turbulence occurs in the channel C to influence flowing speed, and the internal joining line A1 is welded with the inner welding line B1 to produce a welding gap, thus damaging welding surface and the inner welding line B1 as high-pressure fluid flows through the conventional pipe joint.

The present invention has arisen to mitigate and/or obviate the afore-described disadvantages.

### SUMMARY OF THE INVENTION

The primary objective of the present invention is to provide a pipe joint structure which after a body is connected with a connection tube, because a hollow channel is flat and does not have any connecting gap or welding trace, a metal structure is not broken in working process, and high-pressure fluid flows through the hollow channel quickly and safely.

Accordingly, a pipe joint structure provided by the present invention has a pipe joint and contains: a body, a connection ring, and a screwing nut.

The body includes a hollow channel defined therein, a connecting tube surrounding around the hollow channel and having at least one end which is open, and a coupling section arranged adjacent to an end portion of an outer wall of the connecting tube.

The connection ring includes an inner joining diameter for connecting with the coupling section of the body.

The screwing nut includes an internal orifice defined therein, wherein an outer diameter of the internal orifice is greater than the body and the connection ring, and the internal orifice has inner threads formed around inner wall thereof and has a limiting rib arranged on one end of the internal orifice facing to the body, wherein an outer diameter of the internal orifice is greater than an outer diameter of the body and is smaller than an outer diameter of the connection ring.

Thereby, the limiting rib of the internal orifice of the screwing nut is inserted into the connecting tube of the body, the inner joining diameter of the connection ring connects with the coupling section of the body, and the connection ring stops the limiting rib of the screwing nut, such that the screwing nut rotates on the connecting tube fixedly, hence after the connection ring is in connection with the body, on an outer surface of the body forms a fixing line which is welded to form a welding line.

### BRIEF DESCRIPTION OF THE DRAWINGS

FIG. 1 is a perspective view showing the exploded components of a conventional pipe joint structure.

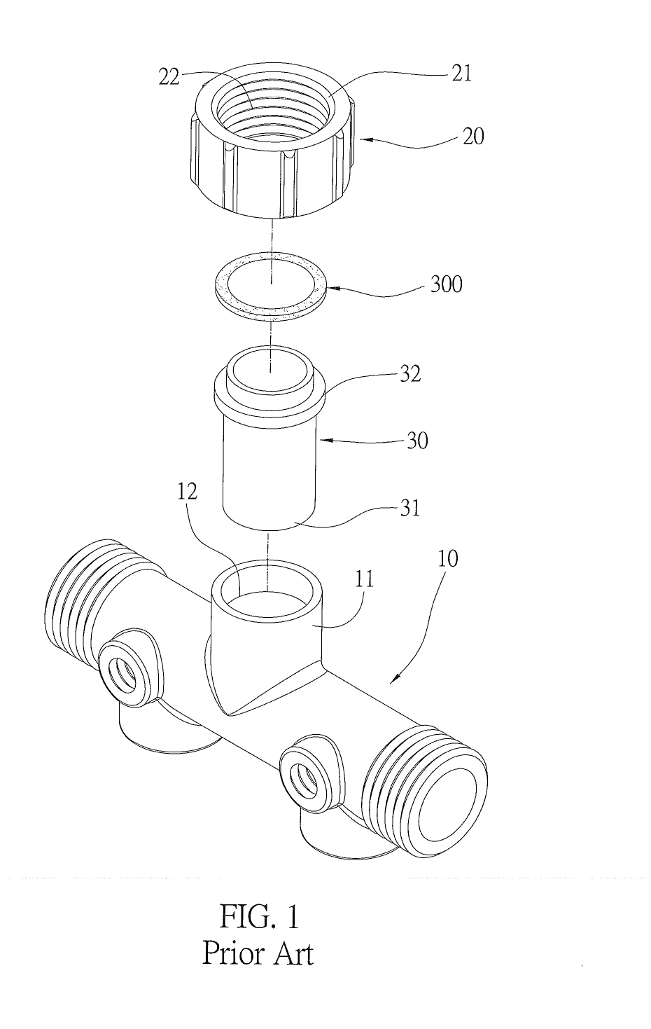

FIG. 2 is another perspective view showing the assembly of the conventional pipe joint structure.

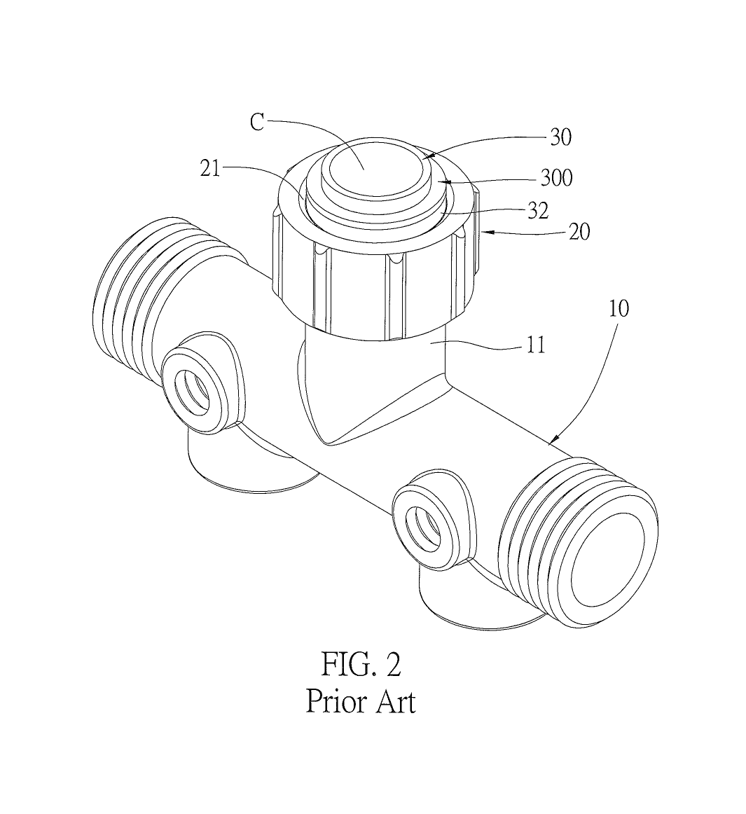

FIG. 3 is a cross sectional view showing the assembly of a part of the conventional pipe joint structure.

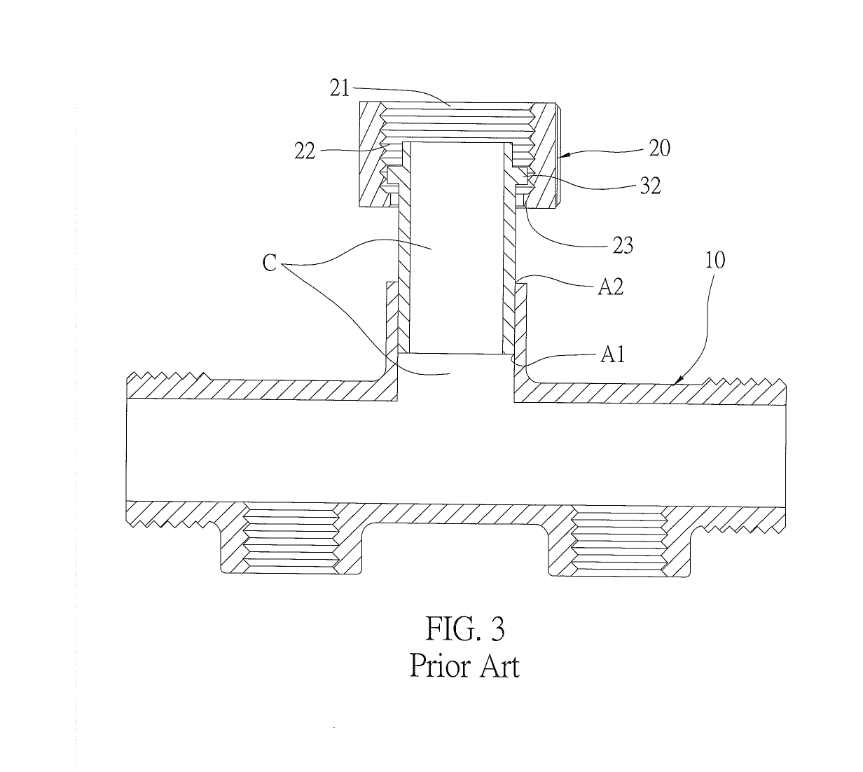

FIG. 4 is a cross-sectional perspective view showing the assembly of a part of the conventional pipe joint structure.

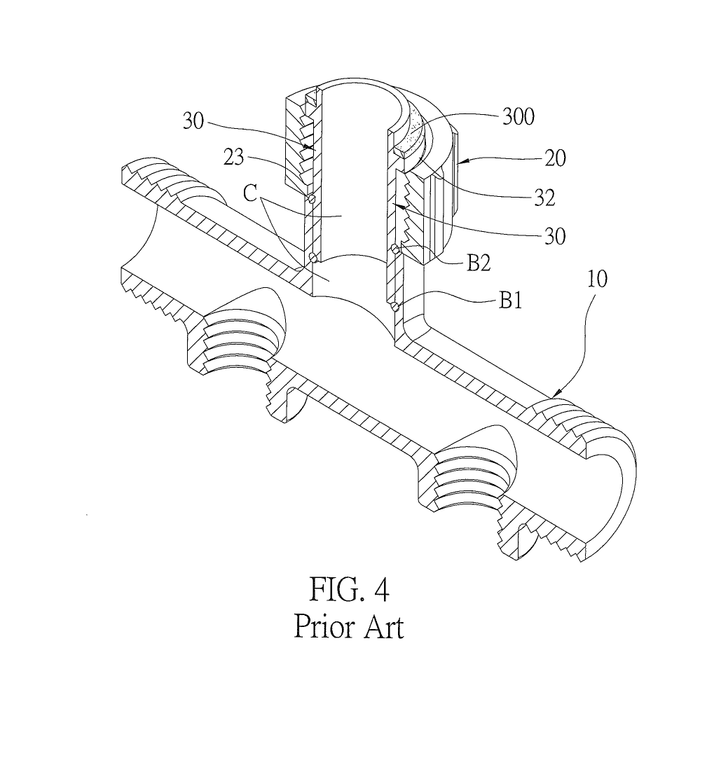

FIG. 5 is a cross sectional view showing the assembly of the conventional pipe joint structure.

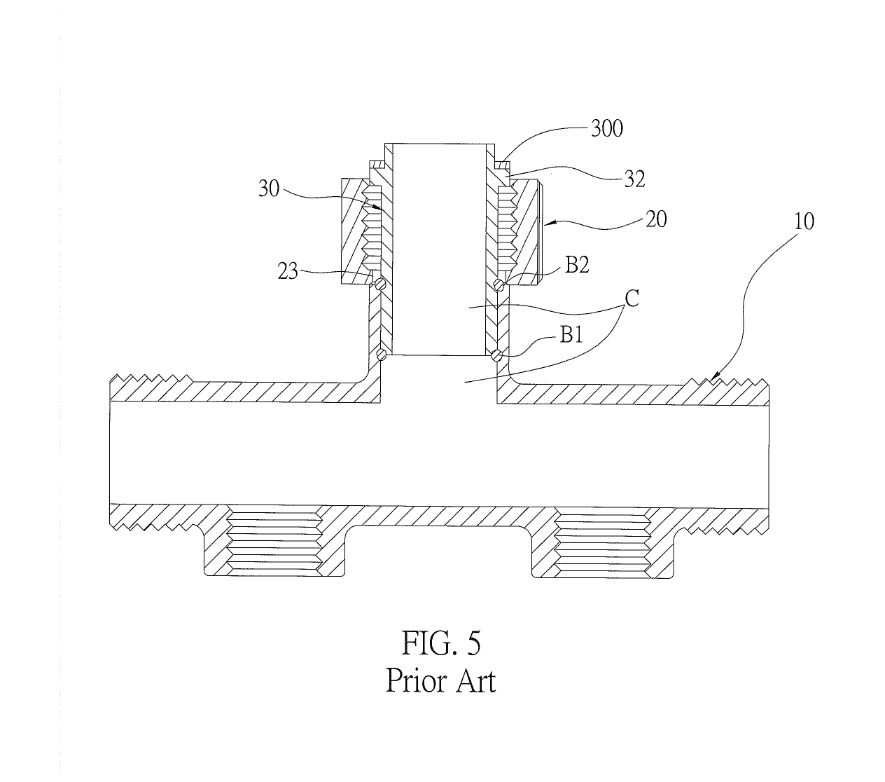

FIG. 6 is a cross sectional view showing the operation of the conventional pipe joint structure.

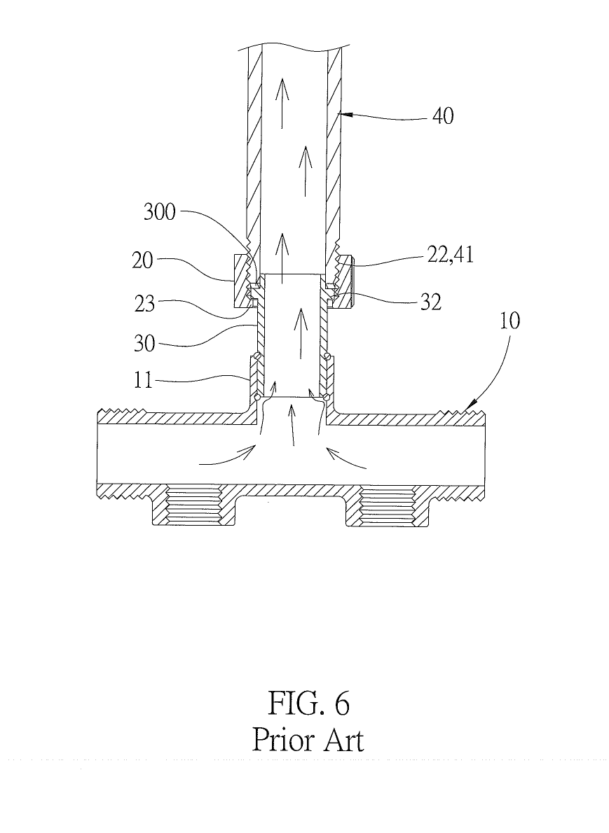

FIG. 7 is a perspective view showing the assembly of a pipe joint structure according to a preferred embodiment of the present invention.

FIG. 8 is a perspective view showing the exploded components of the pipe joint structure according to the preferred embodiment of the present invention.

FIG. 9 is a cross sectional view showing the assembly of the pipe joint structure according to the preferred embodiment of the present invention.

FIG. 10 is a cross sectional perspective view showing the assembly of a part of the pipe joint structure according to the preferred embodiment of the present invention.

FIG. 11 is a cross sectional view showing the assembly of the pipe joint structure according to the preferred embodiment of the present invention.

FIG. 11A is an amplified cross sectional view of FIG. 11.

FIG. 12 is a cross sectional view showing the operation of the pipe joint structure according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

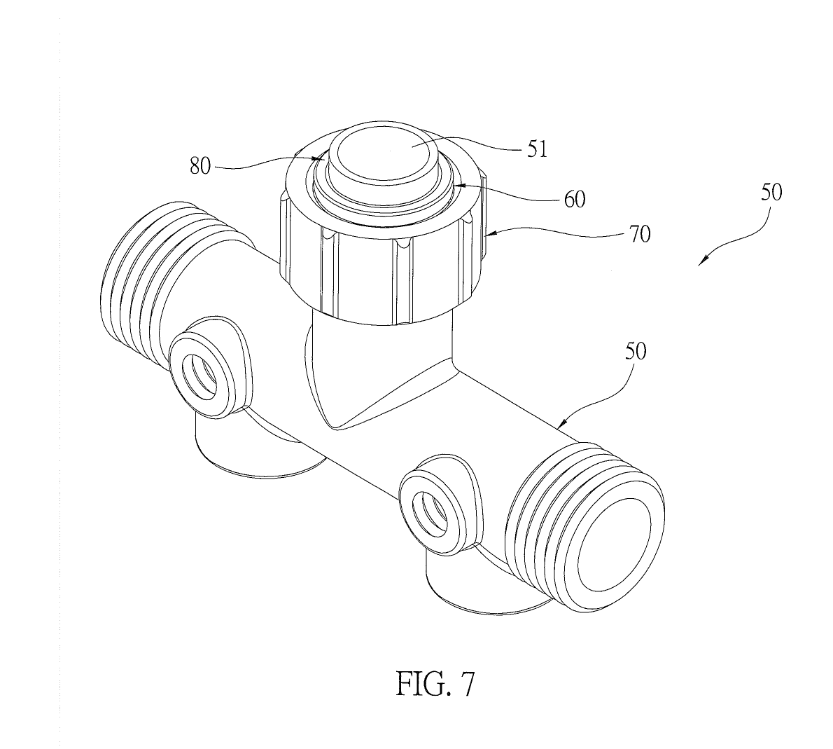

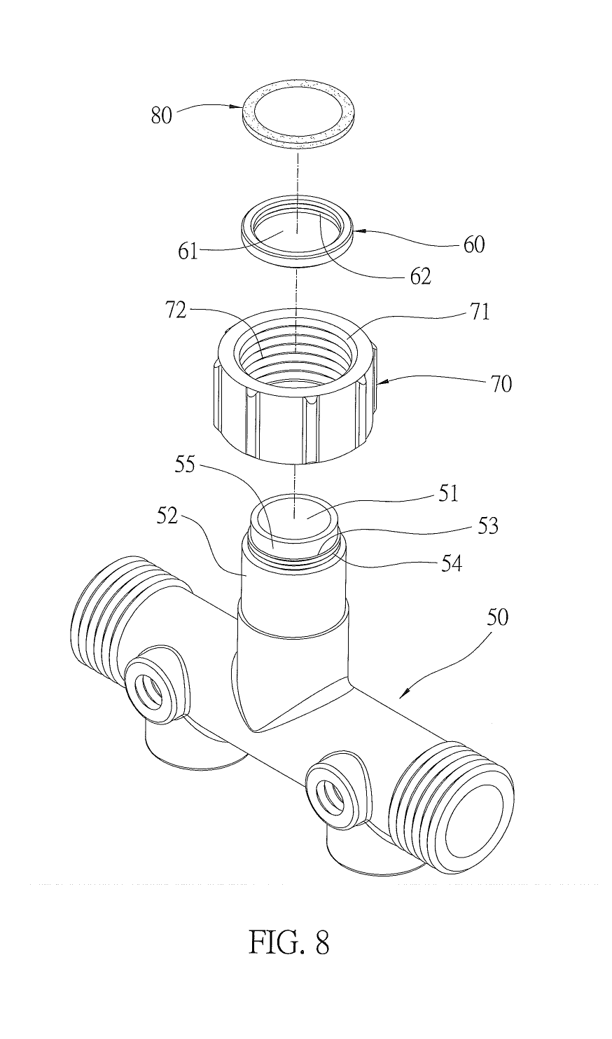

With reference to FIGS. 7 and 8, a pipe joint 1 according to a preferred embodiment of the present invention comprises:
a body 50 including a hollow channel 51 defined therein, a connecting tube 52 surrounding around the hollow channel 51 and having at least one end which is open, a coupling section 53 arranged adjacent to an end portion of an outer wall of the connecting tube 52, first outer threads 54 formed on the coupling section 53, and a fitting section 55 extending outwardly from the coupling section 53, wherein an outer diameter of the fitting section 55 is smaller than that of the coupling section 53;

a connection ring 60 including an inner joining diameter 61 for connecting with the coupling section 53 of the body 50, and the connection ring 60 also including first inner threads 62 formed on the inner joining diameter 61, such that the first inner threads 62 screw with the first outer threads 54;

a screwing nut 70 including an internal orifice 71 defined therein, wherein an outer diameter of the internal orifice 71 is greater than the body 50 and the connection ring 60, and the internal orifice 71 has second inner threads 72 formed around inner wall thereof and has a limiting rib 73 arranged on one end of the internal orifice 71 facing to the body 50, wherein an outer diameter of the internal orifice 71 is greater than an outer diameter of the body 50 and is smaller than an outer diameter of the connection ring 60.

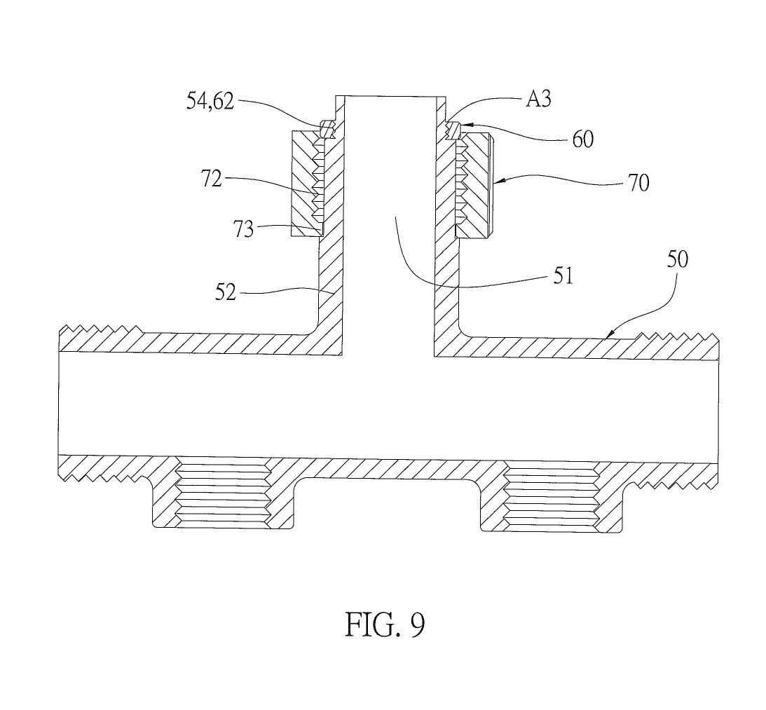

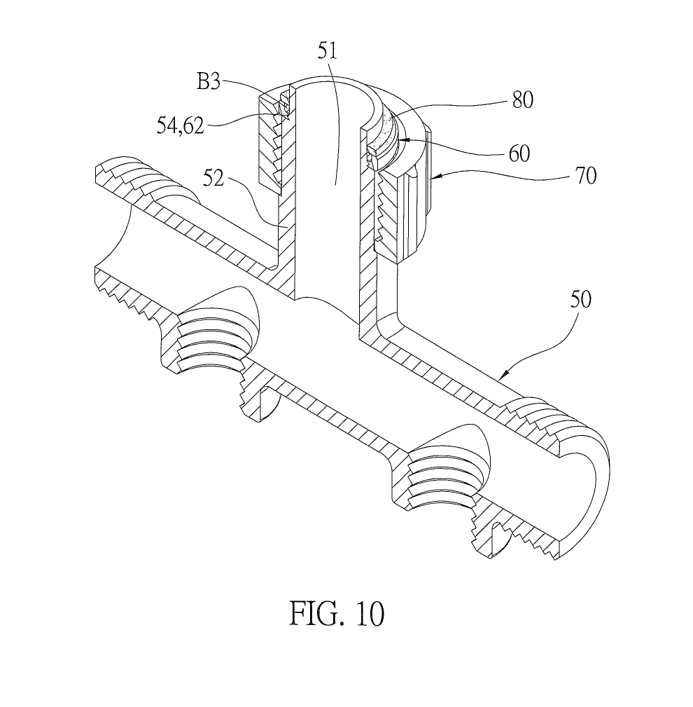

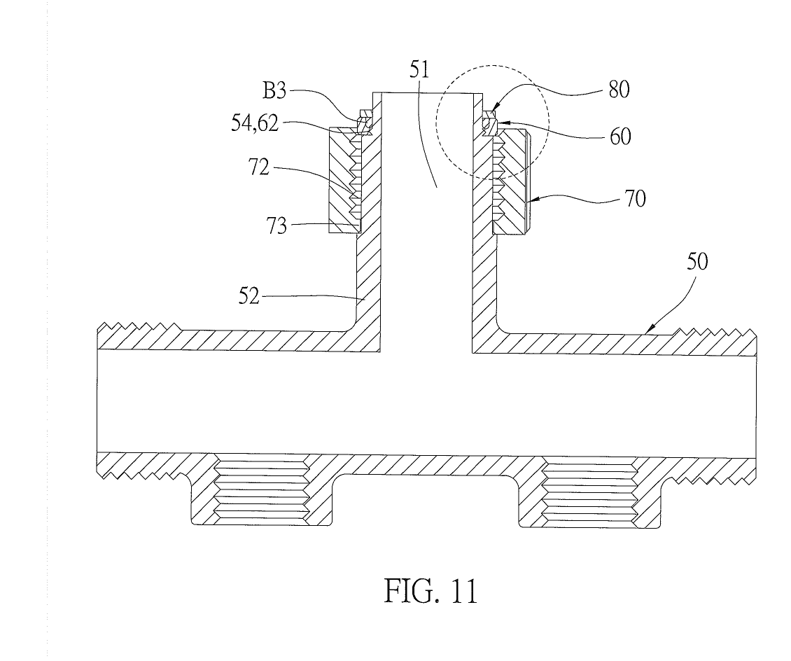

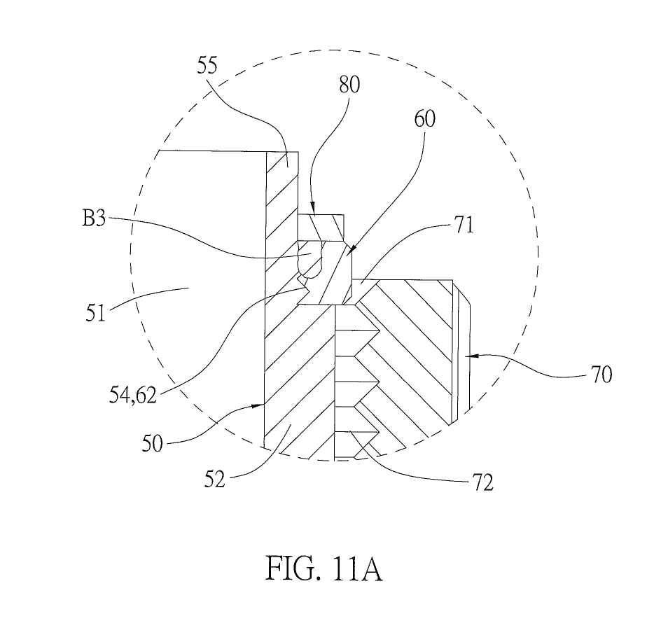

In assembly, as shown in FIGS. 9 and 10, the limiting rib 73 of the internal orifice 71 of the screwing nut 70 is inserted into the connecting tube 52 of the body 50, the inner joining diameter 61 of the connection ring 60 connects with the coupling section 53 of the body 50 by screwing the first inner threads 62 with the first outer threads 54. In addition, the inner joining diameter 61 is engaged with the coupling section 53 so that the connection ring 60 stops the limiting rib 73 of the screwing nut 70, and the screwing nut 70 rotates on the connecting tube 52 fixedly, hence after the connection ring 60 is in connection with the body 50, on an outer surface of the body 50 forms a fixing line A3 which is welded to form a welding line B3, as illustrated in FIGS. 10, 11, and 11A.

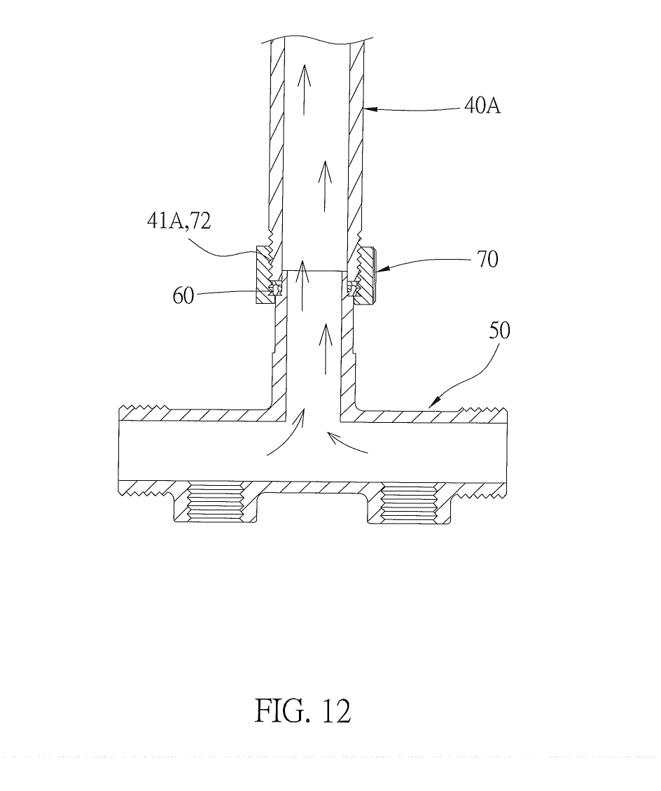

Thereby, the pipe joint 1 is connected with a connection tube 40 by ways of the connecting tube 52 of the body 50, wherein the connection tube 40 includes second outer threads 41 arranged on an outer wall thereof, and the body 50 is screwed with the second outer threads 41 by using the second inner threads 72 of the screwing nut 70 so that the connecting tube 52 of the body 50 couples with the connection tube 40 tightly. Preferably, between the connecting tube 52 of the body 50 and the connection tube 40 is fixed a closing ring 80 to stop the liquid. Referring to FIG. 12, after the body 50 is coupled with the connection tube 40, because the hollow channel 51 is flat and does not have any connecting gap or welding trace, high-pressure fluid flows through the hollow channel 51 quickly and stably.

While we have shown and described various embodiments in accordance with the present invention, it is clear to those skilled in the art that further embodiments may be made without departing from the scope of the present invention.

What is claimed is:

1. A pipe joint structure having a pipe joint, and the pipe joint comprising:
a body including a hollow channel defined therein, a connecting tube surrounding around the hollow channel and having at least one end which is open, and a coupling section arranged adjacent to an end portion of an outer wall of the connecting tube;
a connection ring including an inner joining diameter for connecting with the coupling section of the body;
a screwing nut including an internal orifice defined therein, wherein an outer diameter of the internal orifice is greater than the body and the connection ring, and the internal orifice has inner threads formed around inner wall thereof and has a limiting rib arranged on one end of the internal orifice facing to the body, wherein an outer diameter of the internal orifice is greater than an outer diameter of the body and is smaller than an outer diameter of the connection ring;
hence the limiting rib of the internal orifice of the screwing nut is inserted into the connecting tube of the body, the inner joining diameter of the connection ring connects with the coupling section of the body, and the connection ring stops the limiting rib of the screwing nut, such that the screwing nut rotates on the connecting tube fixedly, hence after the connection ring is in connection with the body, on an outer surface of the body forms a fixing line which is welded to form a welding line.

2. The pipe joint structure as claimed in claim 1, wherein the body also includes a fitting section extending outwardly from the coupling section, and an outer diameter of the fitting section is smaller than that of the coupling section.

3. The pipe joint structure as claimed in claim 1, wherein the inner joining diameter is engaged with the coupling section.

4. A pipe joint structure being used to accommodate a lock and comprising:
a body including a hollow channel defined therein, a connecting tube surrounding around the hollow channel and having at least one end which is open, and outer threads formed adjacent to an end portion of an outer wall of the connecting tube;
a connection ring including an inner joining diameter on which first inner threads are formed to screw with the outer threads;
a screwing nut including an internal orifice defined therein, wherein an outer diameter of the internal orifice is greater than the body and the connection ring, and the internal orifice has second inner threads formed around inner wall thereof and has a limiting rib arranged on one end of the internal orifice facing to the body, wherein an outer diameter of the internal orifice is greater than an outer diameter of the body and is smaller than an outer diameter of the connection ring;
hence the limiting rib of the internal orifice of the screwing nut is inserted into the connecting tube of the body, the first inner threads of the connection ring screw with outer threads of the connecting tube, and the connection ring stops the limiting rib of the screwing nut, such that the screwing nut rotates on the connecting tube fixedly, hence after the connection ring is in connection with the body, on an outer surface of the body forms a fixing line.

5. The pipe joint structure as claimed in claim 4, wherein the body also includes a fitting section extending outwardly from the outer threads of the connecting tube, and an outer diameter of the fitting section is smaller than that of the coupling section.

6. The pipe joint structure as claimed in claim 4, wherein the fixing line is welded to form a welding line.
